(19) United States
(12) Patent Application Publication
(10) Pub. No.: US 2005/0162587 A1
(43) Pub. Date: Jul. 28, 2005

(54) Tft liquid cyrstal display panel using micro lens array and manufacturing method thereof

(76) Inventor: Hong-bin Jeon, Gyeonggi-do (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(21) Appl. No.: 10/512,886

(22) PCT Filed: Oct. 21, 2003
(86) PCT No.: PCT/KR03/02206

(30) Foreign Application Priority Data
Oct. 21, 2002 (KR) 10-2002-0064225

(51) Int. Cl. G02F 1/1335

(52) U.S. Cl. 349/95

(57) ABSTRACT

The present invention is related to the liquid crystal display panel using micro lens array and manufacturing method thereof, the present invention comprising; first step for forming photoresist in regular interval on first transparent substrate; second step for forming a certain size groove to etch regular interval; third step for eliminating impurities and photoresist on first transparent substrate; and fourth step for union first transparent substrate and second transparent substrate to use direct bonding method.

### TECHNICAL FIELD

The present invention generally relates to a TFT liquid crystal display panel used for a liquid crystal projector and a manufacturing method thereof, and more specifically, to a TFT liquid crystal display panel using a micro lens array formed by forming lenses between two sheets of transparent substrates and coupling the two sheets of the transparent substrates through a direct bonding process and a manufacturing method thereof.

### BACKGROUND ART

Generally, a liquid crystal display panel displays images by transmitting or cutting off light, and can brightly display the images when there is much transmitted light.

A degree of the transmitted light is called an opening ratio, which shows a ratio of light passing through the liquid crystal display panel among irradiated lights. As higher the opening ratio is, a brighter image is displayed. Thus, the liquid crystal display panel can display the image to be more harmonized with natural colors.

In order to improve the opening ratio, a method of using a micro lens array has been suggested, which enabled light incident on a light cut-off region to be refracted by using the micro lens array and be irradiated to a light transmission region. As a result, when the same bright light source is used, a brighter image is displayed since much light is transmitted in the light transmission region.

FIG. 1 is a diagram illustrating a sectional view in accordance with a manufacturing process of a micro lens array by prior art. Referring to FIG. 1, pattern photo registers (11) on a transparent substrate (10) (a), then the photo registers (11) are formed as many consecutive convexly-curved surfaces on the transparent substrate (0) by being reflowed. When an upper part of the transparent substrate is dry-etched, many convex lens-shaped flexions are formed in the upper part of the transparent substrate (10) (c). Then, a synthetic resin (12) is smoothly coated in the upper part of the transparent substrate (110), where the convex lens-shaped flexions are formed.

Since the synthetic resin and the flexions of the transparent substrate become micro lenses, respectively, by refraction index differences between the synthetic resin (12) and the transparent substrate (10), a micro lens array consisting of the micro lenses is formed in the upper part of the transparent substrate.

Also, a dustproof substrate (20) is attached to the upper part of the transparent substrate where the micro lens array is formed (e).

The reason why the dustproof substrate is attached to such micro lens array is as follows: when a liquid crystal display panel expands a displayed image on a projection lens and displays the expanded image on a screen, the projection lens focuses on the liquid crystal display panel; at this time, if foreign substance such as dust is attached to a surface of the liquid crystal display panel, the foreign substance is expanded by the projection lens due to the thin liquid crystal display panel and is displayed like an image on the screen. To solve the above problem, the dustproof substrate is attached to both sides of the liquid crystal display panel, to make the liquid crystal display panel thick. Accordingly, even though foreign substance such as dust is attached to the surface of the liquid crystal display panel, the foreign substance is separated from a focus of the projection lens at more than a certain distance, thereby preventing the foreign substance such as dust from being shown on the screen.

In addition, when light is irradiated on the liquid crystal display panel, it causes heat on the liquid crystal display panel. On this occasion, if excessive heat is generated thereon, there produces a displaying problem on the liquid crystal display panel. Therefore, it is necessary for the liquid crystal display panel to stand the heat by attaching the dustproof substrate thereto and distributing the heat generated on the liquid crystal display panel.

However, a prior micro lens array is manufactured by using a synthetic resin, which is weak in heat. A TFT liquid crystal device has a transparent electrode with the use of an ITO (Indium Tin Oxide). To obtain a high-quality transparent electrode, it should be processed at more than 230° C., approximately. On the other hand, since the synthetic resin does not stand high temperature like 230° C. above, it is essential to form the transparent electrode in the micro lens array including the synthetic resin at about 180˜200° C. by using an LT (Low Temperature) ITO processing method. So, it is impossible to form the high-quality transparent electrode, resulting in transmittance deterioration of the transparent electrode and an increase of resistance.

Furthermore, the prior micro lens array using the synthetic resin has difficulty in cutting as well.

Generally, a scribe breaking method is used to cut the micro lens array. That is, after flawing an upper side of glass (or quartz) by scratching it in a position to be cut, cut an upper part of the flawed side by a vertical force in vertical direction to the upper side. The vertical force is transmitted in vertical direction to the upper side on the glass (or quartz), but the direction of the vertical force is changed in a region of the synthetic resin (12), preventing the cut side from being vertically formed. Therefore, according to the prior micro lens array, it is unavailable to apply a manufacturing method for cutting the micro lens array in a post process after attaching the micro lens array to the liquid crystal panel having a TFT element.

And, because the dustproof substrate is attached to the transparent substrate by using the synthetic resin, there is a possibility of changing cell gaps of the liquid crystal display panel owing to different thermal expansion coefficients of the synthetic resin, the dustproof substrate, and the transparent substrate when heat is applied. Also, an additional operation such as a process for attaching the dustproof substrate is required, making a process of manufacturing the liquid crystal display panel complex at high price.

Moreover, light transmittance of the liquid crystal display panel may deteriorate due to an adhesive, with a possibility of attaching foreign substance while attaching the dustproof substrate to the liquid crystal display panel. Accordingly, it causes various problems such as increased costs with managerial difficulty for preventing the above shortcomings, as well as removal of bubbles and folds.

In addition, since the synthetic resin used to form the micro lens array has temperature limits, it is impossible to adopt a method for applying a transparent electrode at temperature which a general transparent electrode is applied to.

### DISCLOSURE OF INVENTION

It is therefore an object of the present invention to provide a micro lens array that freely performs a cell cutting operation and does not restrict a transparent electrode forming process at low temperature, without using another optical adhesive, a liquid crystal panel using the same, and a manufacturing method thereof. It is another object of the present invention to provide a TFT liquid crystal display panel using a micro lens array formed without attaching another dustproof substrate thereto when a thick transparent substrate is used to form the micro lens array and a manufacturing method thereof.

To accomplish the above object, the present invention comprises a first step of consecutively forming photo registers on a first transparent substrate, said each photo register being separated at predetermined interval; a second step of forming grooves with predetermined size on an upper part of the first transparent substrate by etching the predetermined intervals formed between the photo registers; a third step of removing impurities remaining on the upper part of the first transparent substrate and the photo registers; and a fourth step of uniting a second transparent substrate with the upper part of the first transparent substrate by a direct bonding method; wherein the first transparent and the second transparent substrate are made of same material.

At this time, it is desirable to perform a wet etching process for the etching process carried out in the above manufacturing method, and is desirable to add a process of patterning a transparent conductive film or a process of grinding the transparent substrate after the direct bonding process.

Also, to accomplish the above object, the present invention comprises the steps of: a first step of reflowing photo registers to make them in spherical shape after consecutively forming the photo registers on a first transparent substrate, being separated at predetermined intervals; a second step of forming grooves having predetermined size in an upper part of the first transparent substrate by etching the predetermined intervals formed between the reflowed photo registers; a third step of removing impurities remaining in the upper part of the first transparent substrate and the photo registers; and a fourth step of uniting a second transparent substrate with the upper part of the first transparent substrate by a direct bonding method. The first transparent substrate and the second transparent substrate are made of the same material.

On this occasion, it is available to use either of a wet etching or a dry etching process for the etching process performed in the above manufacturing method, and is desirable to add a process of patterning a transparent conductive film or a process of grinding the transparent substrate after carrying out the direct bonding process.

To carry out another object, in a micro lens array refracting light incident on a light cut-off region to a light transmission region, the present invention comprises: a first transparent substrate; a second transparent substrate united with the first transparent substrate in a direct bonding method without using another adhesive; and grooves disposed on at least one side of the first transparent substrate and the second transparent substrate in a region where the first transparent substrate and the second transparent substrate are united together, and consecutively formed in certain size. The first transparent substrate and the second transparent substrate are made of the same material.

The above micro lens array improves an opening ratio by being attached to a liquid crystal panel, thereby enabling a liquid crystal display device to be manufactured with better picture quality.

### BRIEF DESCRIPTION OF DRAWINGS

FIG. 1 is a diagram illustrating a sectional view in accordance with a manufacturing process of a micro lens array by prior art.

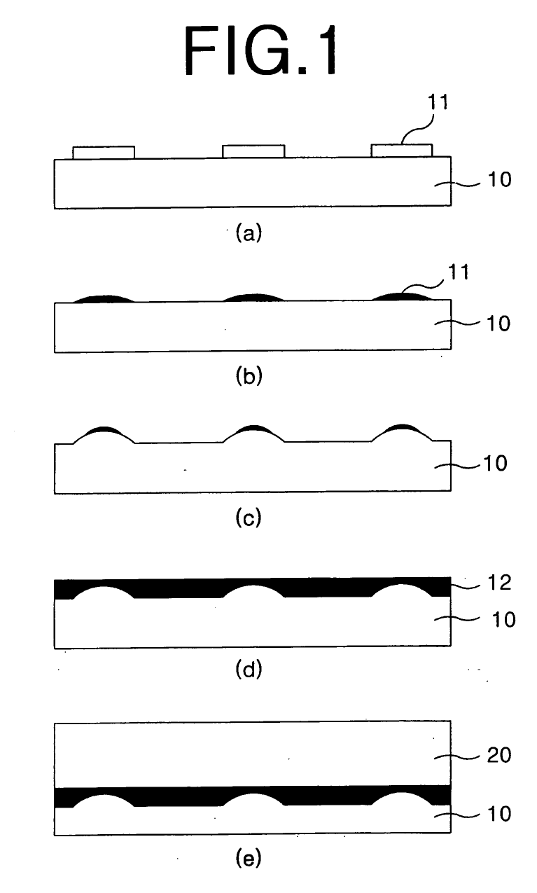

FIG. 2 is a process flow chart of a micro lens array manufacturing process in accordance with one embodiment of the present invention.

FIG. 3 is a diagram illustrating a sectional view of a manufacturing process of a micro lens array in accordance with one embodiment of the present invention.

FIG. 4 is a process flow chart of a micro lens array manufacturing process in accordance with another embodiment of the present invention.

FIG. 5 is a diagram illustrating a sectional view of a manufacturing process of a micro lens array in accordance with another embodiment of the present invention.

### BEST MODE FOR CARRING OUT THE INVENTION

The present invention will be described in detail through preferred embodiments with reference to accompanying drawings, compared to prior art.

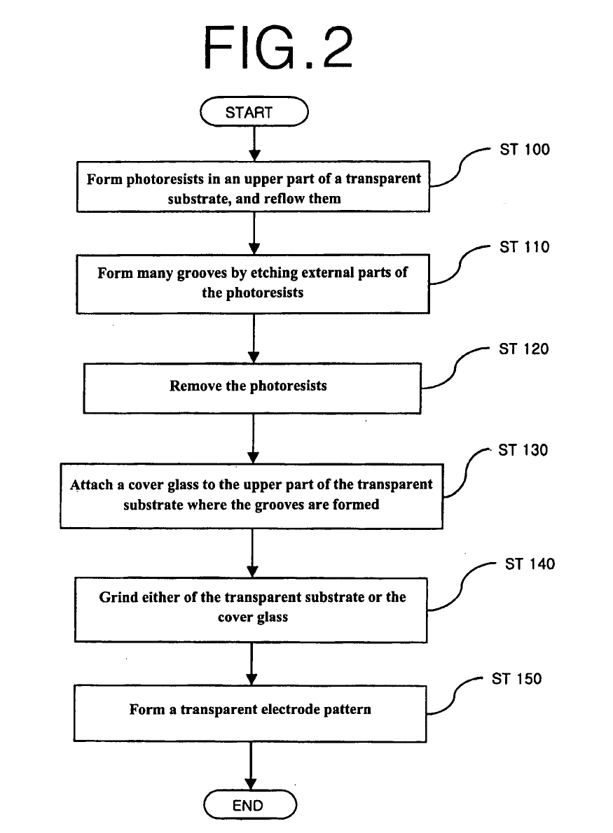

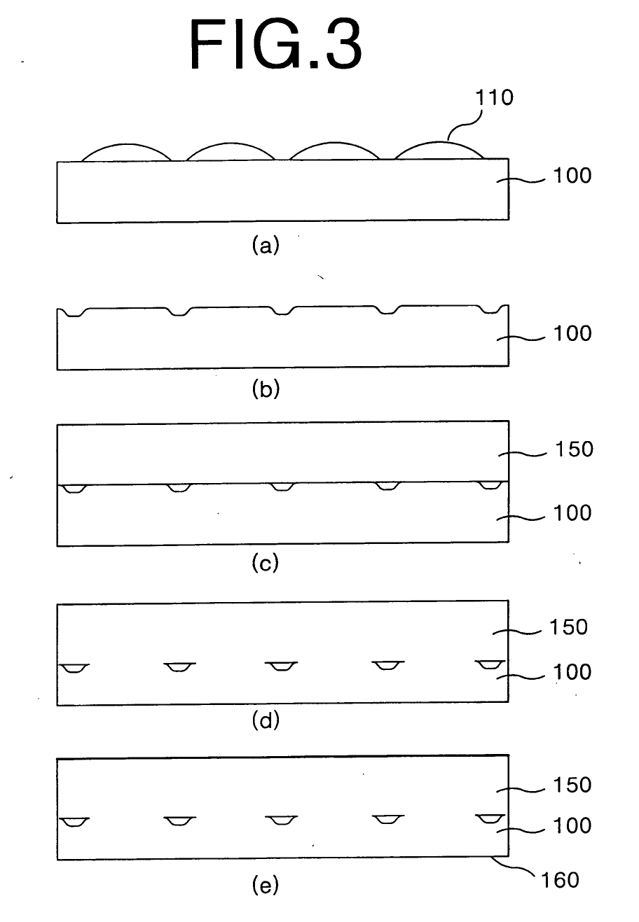

As one embodiment of a micro lens array in accordance with the present invention, FIG. 2 is a flow chart illustrating a manufacturing process, and FIG. 3 is a diagram illustrating a sectional view in accordance with a manufacturing process of a micro lens array. The present invention now will be described in reference to FIG. 2 and FIG. 3 as follows.

A first step (ST 100): By reflowing after applying and patterning photo resisters (110) on a thick transparent substrate (100), the photo registers (110) on the transparent substrate (100) are consecutively formed with patterns having convex curved surfaces like circular convex lens shapes on upper parts of pixels (drawing 3a). At this time, the formed photo registers (110) are about 10˜20 um in size, and gaps between the photo registers (110) are about 0.8 um in size. They are shown on the drawing just for convenience sake.

When the transparent substrate (100) gets thicker, first it can stand heat by distributing the heat generated from light irradiated from a light source on the transparent substrate (100). Second, it is unnecessary to use a dustproof substrate by separating foreign substance such as dust attached to the transparent substrate (100) from a focal distance of a lens at more than a certain distance, since the focal distance of the lens expanding an image on a projector for displaying the image with the use of a liquid crystal display panel is adjusted to a liquid crystal layer.

Thickness of the transparent substrate (100) should be controlled in order to assemble and use by a manufacturing equipment of an existing liquid crystal display panel.

If the transparent substrate is thin, it is ineffective to prevent foreign substance from being displayed because the foreign substance is near to a focus of a projection lens. On the other hand, if too thick, it is difficult to assemble the transparent substrate by using an existing manufacturing equipment even though a screen is little affected by foreign substance, with a possibility of transmitted light being reduced. Thus, it is desirable for the transparent substrate to be about 1.3 mm and 2.5 mm in thickness.

A second step (ST 110): Partially etch the upper part of the transparent substrate (100) where the photo registers (110) having the convex curved surfaces are applied. When a dry etching process is applied, perform the etching process after forming the photo registers (110) in convex lens shape itself by reflowing the photo registers. In case of a wet etching process, form a lens shape at a desirous angle by wet-etching general patterns. For the dry etching process, an etched region is a part where height of the photo registers (110) is lowest, and is an external part of each convex curved surface.

So, grooves having certain curved surfaces are formed in a region where external parts of convex curved surfaces of the transparent substrate (100) are located. Since each groove is formed in the external parts of the convex curved surfaces, each groove is connected together in a neighboring part through the convex curved surfaces (drawing 3b). The photo registers (110) remain in a region where the dry etching process is not carried out.

A third step (ST 120): Many grooves are formed with certain curved surfaces in the upper part of the flat transparent substrate (100) when the photo registers remaining on the transparent substrate (100) and impurities are removed through ashing/strip processes. As a model example of the ashing/strip processes, remove the photo registers by using O2 plasma, and strip the still remaining photo registers, impurities, and a polymer with the use of sulphuric acid.

A fourth step (ST 130): Unit a cover glass (150) with the upper part of the transparent substrate (100) where the grooves are formed (drawing 3c). At this moment, the united cover glass (150) should be made of the same material as that of the transparent substrate (100) because a direct bonding method is used. That is, if the transparent substrate (100) is made of quartz, the cover glass (150) should be made of the same material, and if the transparent substrate (100) is made of glass containing a UV blocker, the cover glass (150) should be made of the same glass containing the UV blocker.

A direct bonding process is used for a process of attaching the cover glass (150) to the upper part of the transparent substrate (100) in accordance with the present invention. Though there is a difference in conditions depending on bonding materials, the cover glass (100) is generally attached to the transparent substrate (50) where the grooves are formed, without using an adhesive, through a surface control process of attaching the cover glass by controlling an adhered surface state. The present invention does not use any adhesive by directly attaching the cover glass (150) to the transparent substrate (100). As a result, it can solve a problem of generating bubbles caused when applying the adhesive.

Gas filled inside of the grooves is differentiated, depending on a surrounding environment under which a direct bonding process is performed. In case the direct bonding process is performed in the air, the air is filled. And, if the process is carried out in a vacuum state, the vacuum state is maintained. Thus, the gas filled inside of the grooves has a different refractive index from that of the transparent substrate (100) and the cover glass (150).

Then, the grooves formed in the upper part of the transparent substrate (100) are connected together, and the transparent substrate (100) is attached to the cover glass (150) in parallel, thereby enabling the grooves formed on the transparent substrate (100) to become pores through which the air passes. The pores easily emit heat generated from a liquid crystal display.

In addition, most regions of the transparent substrate (100) are flat. Thus, a path of vertically incident light is not changed since the light passes without being refracted, by closely adhering the transparent substrate (100) to the cover glass (150) in parallel. However, since the grooves formed on the transparent substrate (100) are separated from the cover glass (150) at certain intervals, the incident light is refracted due to a difference between the air of pores disposed between the cover glass (150) and the transparent substrate (100) and curved surfaces of the formed grooves. Therefore, light is refracted according to Snell's law shown in a mathematical formula 1 by the curved surfaces of the grooves and a refractive index difference of the air and the transparent substrate due to the refraction of the light. Accordingly, regions where the grooves are formed play a role of a convex lens, thereby refracting light irradiated to the regions and making the refracted light incident on a region having a flat surface.

For a path of passing light vertically incident on the upper part of the transparent substrate (100), most incident light is not refracted and vertically passes through the transparent substrate (100) and the cover glass (150), since most upper parts of a lens are planarized while the transparent substrate (100) and the cover glass (150) are attached together in parallel. However, a path of light passing through remaining curved surfaces by a spherical edge part plays a role of the lens due to a refractive index difference between the air and the transparent substrate and flexions of the curved surfaces, refracting light according to the Snell's law shown in the mathematical formula 1. Therefore, it is possible to increase an opening ratio of a liquid crystal display panel by locating a light transmission region of a liquid crystal display in a region where the transparent substrate is closely adhered to the cover glass and locating a light cut-off region of the liquid crystal display in a part where the grooves are formed.

$$\frac{sin {θ}_{1}}{sin {θ}_{2}} = \frac{{n}_{2}}{{n}_{1}} \qquad [ Mathematical formula 1 ]$$

A fifth step (ST 140): Grind at least one surface selected from the united transparent substrate (100) and the cover glass (150) (drawing 3d). Since it is hard to handle too thin glass or a thin quartz substrate owing to its weak strength, unnecessary thickness is grinded after carrying out the uniting process by using relatively thick glass or a thick quartz substrate. On this occasion, it is desirable for the substrate to maintain 50 to 100 um in thickness after the grinding process.

A sixth step (ST 150): Apply a transparent electrode (160) at more than high temperature 200° C. to an external surface of the grinded substrate on the transparent substrate (100) or the cover glass (150) (drawing 3e). The reason why the transparent electrode is applied at more than high temperature 200° C. is because there are no thermal restrictions including a problem of melting a synthetic resin by heat, because the synthetic resin is not used as an adhesive unlike prior art.

According to the prior art, the transparent electrode is applied at low temperature because there is a possibility of transforming the synthetic resin by heat at high temperature. However, in case of the present invention, the cover glass (150) is directly attached to the transparent substrate (100), without using a material such as the synthetic resin that is transformed by temperature. Thus, it is available to apply the transparent electrode at high temperature, enabling the transparent electrode to be applied at 230° C.

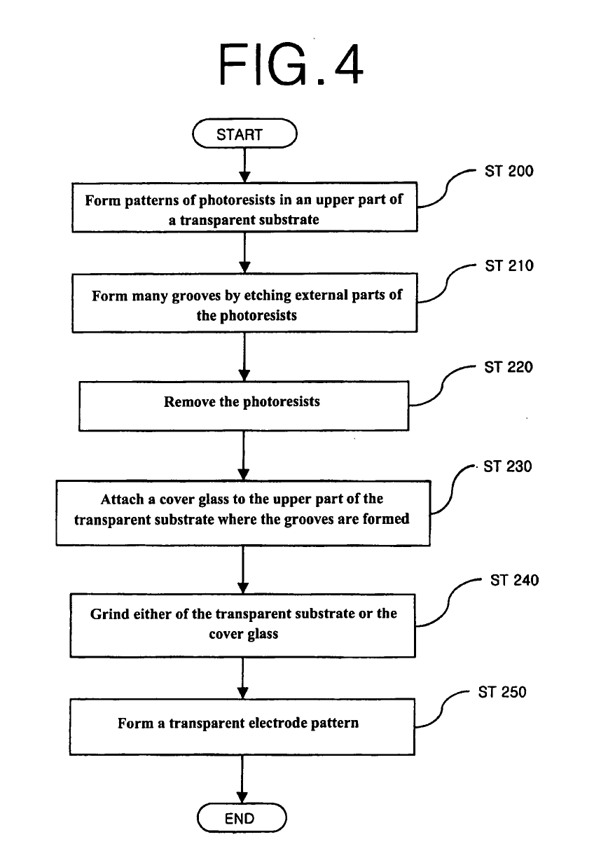

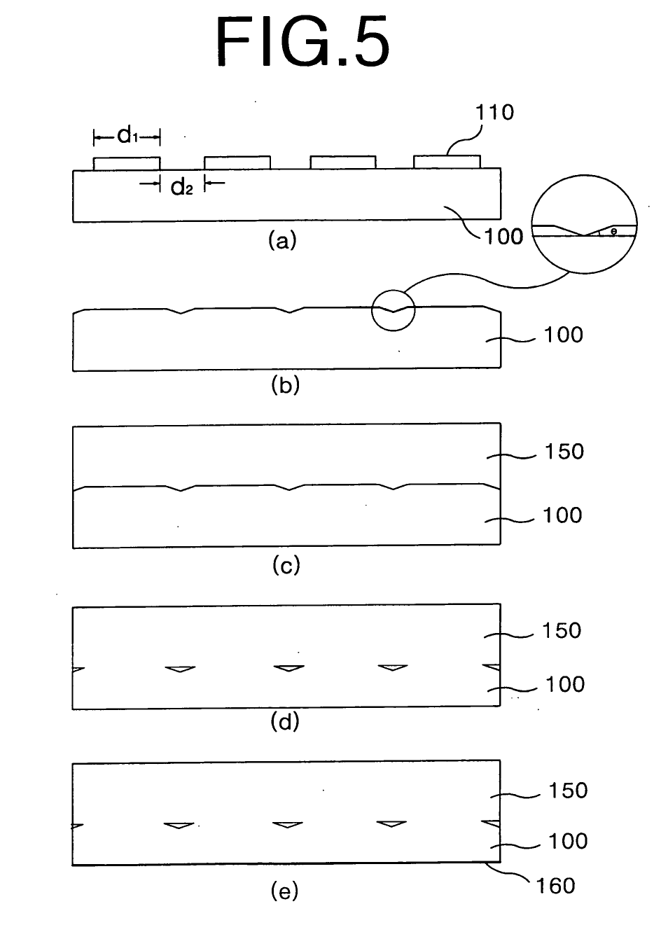

For another embodiment of a micro lens array in accordance with the present invention, FIG. 4 is a flow chart illustrating a manufacturing process, and FIG. 5 is a diagram illustrating a sectional view in accordance with a manufacturing process of a micro lens array. The present invention will be described in reference to FIG. 4 and FIG. 5 as follows.

A first step (ST 200): Apply photo registers (110) on a thick transparent substrate (100), and pattern them (drawing 5a). The formed photo registers (110) are about 10˜20 um in thickness (d1), gaps between the photo registers (110) are about 0.8 um in thickness (d2), and they are shown on the drawing just for convenience sake.

A second step (ST 210): Partially etch an upper part of the transparent substrate (100) where the photo registers (110) are applied. In the present embodiment, a wet etching process is carried out because the photo registers (110) are not reflowed. The wet etching process uses a buffer oxide echant.

So, grooves having certain curved surfaces are formed on the transparent substrate (100) (drawing 5b). Then, the photo registers (110) remain in a region where the etching process is not performed. Like shown in a diagram expanding inside of a circle in FIG. 5, it is desirable to form the grooves at about 15˜20° on the transparent substrate (100) in order to improve an opening ratio.

A third step (ST 220): Many grooves are formed with certain curved surfaces in an upper part of the transparent substrate (100), when the photo registers remaining on the transparent substrate (100) and impurities are removed through ashing/strip processes. As a model example of the ashing/strip processes, remove the photo registers by using 02 plasma, and strip the still remaining photo registers, impurities, and a polymer with the use of sulphuric acid.

A fourth step (ST 230): Unite a cover glass (150) with the upper part of the transparent substrate (100) where the grooves are formed (drawing 5c). At this time, the united cover glass (150) should be made of the same material as that of the transparent substrate (100) since a direct bonding method is used. That is, if the transparent substrate (100) is made of quartz, the cover glass (150) should be made of the same material, and if the transparent substrate (100) is made of glass containing a UV blocker, the cover glass (150) should be made of the same glass containing the UV blocker.

A fifth step (ST 240): Grind at least one surface selected from the united transparent substrate (100) and the cover glass (150) (drawing 5d). Since it is hard to handle too thin glass or a thin quartz substrate owing to its weak strength, unnecessary thickness is grinded after carrying out the uniting process by using relatively thick glass or a thick quartz substrate.

A sixth step (ST 250): Apply a transparent electrode (160) at more than high temperature 200° C. to an external surface of the grinded substrate on the transparent substrate (100) or the cover glass (150) (drawing 5e).

### INDUSTRIAL APPLICABILITY

According to a TFT liquid crystal display panel using a micro lens array formed in accordance with the present invention and a manufacturing method thereof, it is possible to perform other processes at high temperature since an adhesive such as a sort of a synthetic resin is not used while manufacturing the micro lens array. Thus, it can use a process of forming a transparent electrode by using an ITO requiring about 230° C., thereby forming a high-quality transparent electrode having good transmittance and conductivity.

Furthermore, it is easy to cut the micro lens array, because a synthetic resin is not used. Accordingly, it is available to perform a manufacturing method for cutting the micro lens array in a post process after attaching the micro lens array to a liquid crystal panel having a TFT element.

And, if either of transparent substrates used to manufacture the micro lens array is thick, it is unnecessary to attach a dustproof substrate. Therefore, it can simplify a manufacturing process of the micro lens array by omitting a process of attaching the dustproof substrate, as well as prevent transmittance from deteriorating by an adhesive.

Moreover, since pores are formed inside of the transparent substrate where the micro lens array is formed, external air is directly contacted with inside of the micro lens array through the pores, thereby easily emitting heat generated from a liquid crystal display panel through the air. As a result, a liquid crystal projector using the liquid crystal display panel to which the micro lens array is attached in accordance with the present invention can easily emit heat. So, compared to an existing liquid crystal projector, it is possible to use a smaller cooling device, reducing weight and size of the liquid crystal projector.

This invention may, however, be embodied in different forms and should not be construed as limited to the embodiments set forth herein. Rather, these embodiments are provided so that this disclosure will be thorough and complete, and will fully convey the scope of the invention to that skilled art.

1. A method of manufacturing a micro lens array, said method comprising:
a first step of consecutively forming photoresists on a first transparent substrate, each photoresist being separated by an interval;
a second step of forming grooves on an upper part of the first transparent substrate by etching the intervals formed between the photoresist;
a third step of removing impurities remaining on the upper part of the first transparent substrate and the photoresists; and
a fourth step of uniting a second transparent substrate with the upper part of the first transparent substrate by a direct bonding method;
wherein the first transparent and the second transparent substrate are made of the same material.

2. The method of claim 1, said method further comprising a fifth step of grinding at least one of the first transparent substrate and the second transparent substrate after the fourth step.

3. The method of claim 1, wherein the etching process performed at the second step is carried out by a wet etching process.

4. The method of claim 2, said method further comprising a sixth step of patterning a transparent electrode on at least one external surface selected from the first transparent substrate or the second transparent substrate.

5. A method of manufacturing a micro lens array, comprising:
a first step of making photoresists in spherical shape by reflowing them after consecutively forming the photoresists on a first transparent substrate, said photoresists being separated at predetermined intervals;
a second step of forming grooves with predetermined size in an upper part of the first transparent substrate by etching the predetermined intervals, said intervals formed between the reflowed photoresists;
a third step of removing impurities remaining in the upper part of the first transparent substrate and the photoresists; and
a fourth step of uniting a second transparent substrate with the upper part of the first transparent substrate by a direct bonding method.

6. The method of claim 5, said method further comprising a fifth step of grinding at least one of the first transparent substrate and the second transparent substrate after the fourth step.

7. The method of claim 6, said method further comprising a sixth step of patterning a transparent electrode on at least one external surface selected from the first transparent substrate or the second transparent substrate.

8. A micro lens array refracting light incident in a light cut-off region to a light transmission region, comprising:
a first transparent substrate;
a second transparent substrate being united with the first transparent substrate by a direct bonding method without using another adhesive; and
grooves disposed in a region where the first transparent substrate and the second transparent substrate are united together and consecutively formed in certain size, said grooves formed on at least one side of the united first transparent substrate and the second transparent substrate.

9. The micro lens array of claim 8, wherein the grooves having slopes, and an angle between the slopes and an upper surface of the transparent substrate being maintained at 15 to 20 degrees.

10. The micro lens array of claim 8, wherein the first transparent substrate and the second transparent substrate being made of quartz or glass containing a UV blocker.

11. The micro lens array of claim 8, wherein a patterned transparent electrode being further comprised on an external side of the first transparent substrate or the second transparent substrate.

12. A liquid crystal panel having a micro lens array according to claim 10.

13. A liquid crystal display device having a micro lens array according to claim 10.

14. The method of claim 1, wherein the photoresists are separated by intervals of about 0.8 μm.

15. The method of claim 1, wherein the photoresists are about 10 to 20 μm in size.
